(19) United States
(12) Patent Application Publication
(10) Pub. No.: US 2014/0093619 A1
(43) Pub. Date: Apr. 3, 2014

(54) READY TO EAT COLD BEAN CAKES WITH INGREDIENTS

(71) Applicant: Alice Chang, South Pasadena, CA (US)

(72) Inventor: Alice Chang, South Pasadena, CA (US)

(21) Appl. No.: 13/928,386

(22) Filed: Jun. 27, 2013

Related U.S. Application Data
(60) Provisional application No. 61/708,420, filed on Oct. 1, 2012.

(51) Int. Cl. A23L 1/20

(52) U.S. Cl. CPC A23L 1/2001
USPC 426/93; 426/634

(57) ABSTRACT

Cold and ready to eat bean cakes, with a variety of ingredient combinations suitable for healthy consumption. Serving size can be a single serving, or a six pack of servings for convenience such that the inherent nutritional aspects of beans are able to be included in consumer's diets.

### CROSS-REFERENCE TO RELATED APPLICATION

The present application is related to and claims priority from prior provisional application Ser. No. 61/708,420 filed Oct. 1, 2012 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of comestibles and more specifically relates to ready to eat cold bean cakes.

2. Description of the Related Art

It is desirable to offer nutritious comestibles for consumption. Nutrition may help individuals avoid health problems. Beans are a healthy food choice; however they may not be in a conveniently readily edible form. Beans are an important source of protein and are widely available for consumption. Further, beans have significant amounts of fiber and soluble fiber, with one cup of cooked beans providing between nine and thirteen grams of fiber. Soluble fiber can help lower blood cholesterol. Beans are also high in complex carbohydrates, folate, and iron. Many people do not eat beans on a regular basis because beans may produce flatulence; beans prepared so as to minimize flatulence would be desirable.

Since people's schedules are busy, convenience may outweigh nutrition which is not desirable in the long-term. It is desirable to have foods such as beans that are nutritious and also convenient to eat. A more efficient option is needed wherein beans can be produced in such a form.

Various attempts have been made to solve the above-mentioned problems such as those found in U.S. Pat. Nos. 5,871,801; 4,748,037; and Pub. Nos. 2010/0285196; 2007/0092619; U.S. Pat. Nos. 6,821,537; and 4,505,942. This art is representative of comestibles relating to beans. None of the above inventions and patents, taken either singly or in combination, is seen to describe the invention as claimed.

Ideally, ready to eat cold bean cakes should provide nutrition and convenience to consumers and, yet would be manufactured at a modest expense. Thus, a need exists for ready to eat cold bean cakes to avoid the above-mentioned problems.

### BRIEF SUMMARY OF THE INVENTION

In view of the foregoing disadvantages inherent in the known bean-related comestibles art, the present invention provides novel ready to eat cold bean cakes. The general purpose of the present invention, which will be described subsequently in greater detail is to provide ready to eat cold bean cakes with a variety of ingredients. The invention is to provide people who shop for beans for food the option of getting processed and cooked bean cakes, cold and ready to eat.

A ready to eat cold bean cake product comprising ingredients is disclosed herein combined in proportions substantially including: beans; milk; a binding agent; additives; and flavorings; wherein beans are soaked, cooked, and processed; wherein milk, binding agent, additives and flavorings are stirred, mixed as an admixture and formed into bean cakes as ready to eat cold bean cake product. The binding agent causes the admixture to congeal after being cooked when the admixture is cooled using refrigeration. The flavorings cause the bean cakes to be suitably flavored for consumption. The bean cakes are a good source of nutrition are and suitable for readily consuming. Various flavored versions of the bean cakes may be produced. Kits may be packaged with ingredients and sold for home cooking.

A method of preparing ready to eat cold bean cakes is also disclosed herein comprising the steps of: removing beans from plants; removing the beans from pods; soaking the beans in soaking water at least one time; discarding a plurality of batches of the soaking water to leach out hard to digest complex sugars that cause flatulence and bloating (desirable as mentioned previously); boiling the beans for 3 minutes in boiling water, then setting aside for 3 to 4 hours; draining and discarding the boiling water and proceeding with cooking; cooking for 1 to 4 hours; draining the boiling water again; converting the beans into a paste with a masher (or other means) to remove their skins; frying the beans with cooking oils; stiffing and mixing with (desired) ingredients, seasonings and the binding agent, and boiling until texture is soft and smooth; forming into bean cakes and storing the bean cakes in a refrigerator to congeal and solidify; and optionally packaging to preserve freshness once solidified.

The present invention holds significant improvements and serves as a ready to eat cold bean cakes system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, ready to eat cold cakes, constructed and operative according to the teachings of the present invention.

FIG. 1 shows a perspective view illustrating ready to eat cold bean cakes according to an embodiment of the present invention.

FIG. 2 is a perspective view illustrating the ready to eat cold bean cakes according to an embodiment of the present invention of FIG. 1.

FIG. 3 is a flowchart illustrating a method of preparing ready to eat cold bean cakes according to an embodiment of the present invention of FIGS. 1-2.

The various embodiments of the present invention will hereinafter be described in conjunction with the appended drawings, wherein like designations denote like elements.

### DETAILED DESCRIPTION

As discussed above, embodiments of the present invention relate to a comestible and more particularly to ready to eat cold bean cakes as used to improve the health of consumers. The purpose as previously mentioned is to create healthy comestibles; ready to eat cold bean cakes, and with a variety of ingredients that minimize flatulence when consumed.

Generally speaking, the purpose as previously mentioned is to create healthy comestibles; ready to eat cold bean cakes, and with a variety of ingredients to choose from when preparing. The beans can include common beans, soy beans, green beans, kidney beans, red beans, pinto beans, white beans, yellow beans, black beans, lima beans, mung beans, broad beans, lentils, peas, chickpeas, and the like. The beans may be taken from the plants and removed from their pods via manual or non-manual means. The dried beans are cooked by boiling, after being soaked for several hours. When the soaking is not necessary, it shortens cooking time and results in more evenly textured beans which is desirable. In addition, discarding one or more batches of soaking water leaches out hard to digest complex sugars that can cause flatulence or bloating making the product more desirable for consumption.

The several methods may include overnight soaking; and the power soak method, which is to boil the beans for 3 minutes, then set aside for 3 to 4 hours, and then drain and discard the water and proceed with cooking. Cooking times vary from 1 to 4 hours, but are substantially reduced with pressure cooking. The cooked bean is drained of the remaining liquid, and converted into a paste with a masher, or pressed through a fine mesh sieve, to remove the skins. Then the bean paste can be fried with cooking oils. The bean paste, fried or not fried, is stirred and mixed with the ingredients, seasonings and the binding agent, and boiled until the texture is soft and smooth.

Cooking oils can also be an ingredient, which may include corn oil, canola oil, peanut oil, olive oil, coconut oil, soybean oil, sesame oil, sunflower oil, flaxseed oil, grape seed oil, pumpkin seed oil, safflower oil, argan oil, rice bran oil, palm oil, palm kernel oil, and the like. Ingredients, as per preference, can include whole milk, lowfat milk, nonfat milk, soy milk, coconut milk, almond milk, vanilla milk, and the like. Other ingredients may include small pieces of cooked vegetables, seafood, and meat. The vegetables can include onion, garlic, spinach, mushroom, carrot, corn, beet, radish, turnip, pepper, tomato, asparagus, cucumber, zucchini, eggplant, squash, pea, avocado, shallot, yam, and the like or combinations thereof. Seafood, when used, may include squid, cuttlefish, shrimp, crab, crayfish, clam, oyster, scallop, lobster, abalone, conch, octopus, jellyfish, prawn, krill, mussel, sea cucumber, sea urchin, eel, snail, shrimp roe, fish roe, fish, and the like. Meat may alternately include chicken, duck, pork, beef, lamb, bacon, sausage, and the like, providing a wide assortment of options. Other ingredients such as coffee, tea, chocolate, caramel, butterscotch, raisin, fruit, nut, cereal, cream, butter, peanut butter, cheese, egg, and the like can be mixed into the bean cakes for an entirely different taste, thus the present invention may be used through a wide scope of diets and preferences.

Fruit juices such as apple juice, orange juice, lemon juice, lime juice, grapefruit juice, grape juice, pear juice, cranberry juice, blueberry juice, pineapple juice, pomegranate juice, coconut juice, etc. can be used to make fruity bean cakes. The bean cakes can also have a topping(s) of different ingredients, such as chocolate, caramel, butterscotch, apple sauce, fruit, nut, cereal, cheese, cream, and the like, or combinations thereof. Flavorings or seasonings can include sugar, syrup, honey, and cinnamon, for example to make sweet bean cakes. Salt, pepper, garlic, ginger, onion, chili, curry, vinegar, lemon, lime, basil, thyme, rosemary, parsley, peppermint, rosemary, clove, cinnamon, coriander, cumin, shallot, soup stock (or broth), and the like may be used to make salty bean cakes, or salty and spicy bean cakes. The binding agent is preferably gelatin, egg white or beaten egg, which has high nutrition in protein. Other binding agents can include vegetable starch, corn starch, potato starch, sago, tapioca, etc.

### EXAMPLES

an example of bean cake is made with soy milk and gelatin. Another example is fried bean cake made with almond milk and gelatin. Yet another example of bean cake is made with carrot, mushroom and gelatin. An example of sweet bean cake may be made with milk, honey, ginger, grapefruit juice and gelatin. Another example of sweet bean cake is made with coconut milk, sugar and gelatin. An example of salty bean cake may be made with sausage, onion, salt, garlic, olive oil and gelatin. An example of salty and spicy bean cake is made with shrimp, salt, ginger, chili, vinegar, flaxseed oil and gelatin. Many other examples exist; however these provide exemplary means for reproducing the product.

Cold and ready to eat bean cakes save people the time and energy of preparing and cooking of the food. They can be served as food for breakfast, lunch, snack, or dinner. Beans have high nutritional value, including complex carbohydrates, protein, dietary fiber, soluble fiber, vitamins and minerals, as previously mentioned therefore it is desirable that they make their way into our diet. Cold and ready to eat bean cakes offer the consumers an easy and convenient way to obtain an affordable, nutritious and delicious meal.

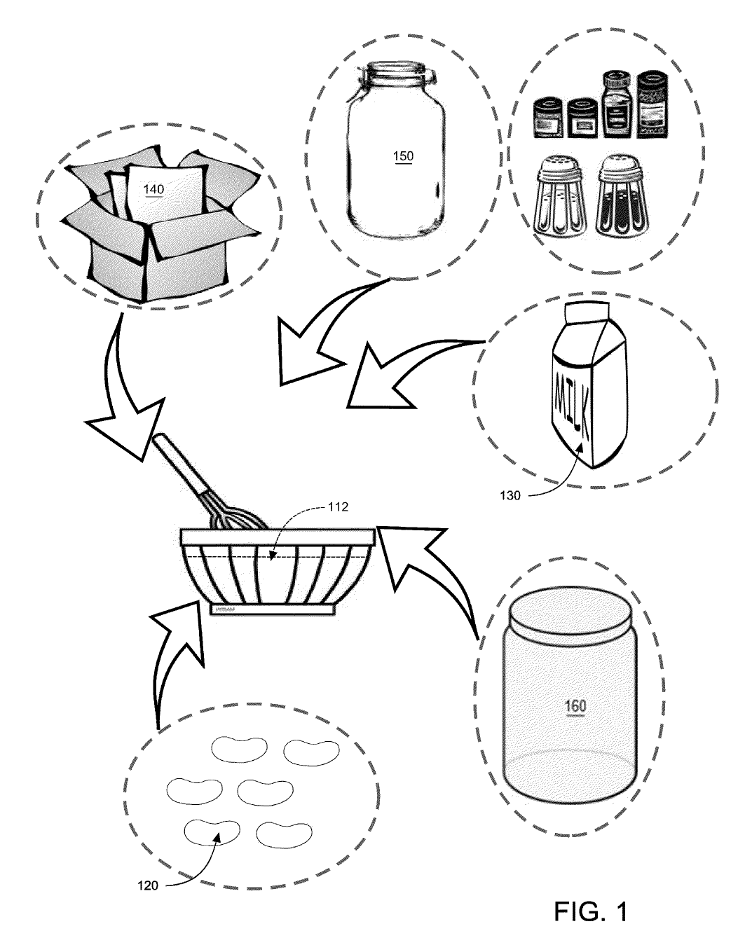

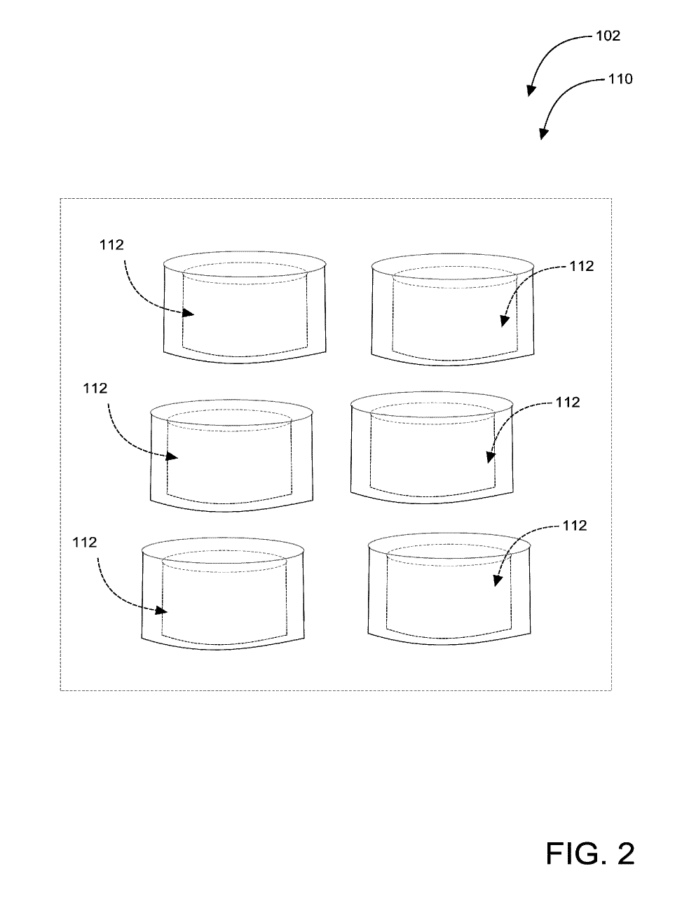

Referring now more specifically to the drawings by numerals of reference there is shown in FIGS. 1-2, perspective views illustrating ready to eat cold bean cakes 110 according to embodiments of the present invention.

Ready to eat cold bean cake product 102 comprising ingredients combined in proportions substantially may preferably include: beans 120; milk 130; binding agent 140; additives 150; and flavorings. Beans 120 are soaked, cooked, and processed. Beans 120 are preferably selected from the group consisting of common beans, soy beans, green beans, kidney beans, red beans, pinto beans, white beans, yellow beans, black beans, lima beans, mung beans, broad beans, lentils, peas, and chickpeas. Other beans may be used. Beans 120, milk 130, binding agent 140, additives 150 and flavorings 160 are stirred, mixed as an admixture and formed into bean cakes 112 as ready to eat cold bean cake product 102. Binding agent 140 causes admixture to congeal after being cooked when admixture is cooled using refrigeration. Flavorings 160 cause bean cakes 112 to be flavored for consumption; bean cakes 112 are high in nutrition, appetizing, and suitable for readily consuming.

Binding agent 140 is an edible binder and preferably comprises gelatin, egg white or beaten egg, which is high in protein, and/or may comprise a starch component such as vegetable starch, corn starch, potato starch, sago, tapioca, in alternate embodiments. Starch component and egg white or beaten egg, when used, allows bean cakes 112 to be reheated in a microwave oven and in a conventional oven for convenience and to minimize food waste. Flavorings 160 are selected from the group consisting of sugar, syrup, honey, cinnamon to make sweet bean cakes. Other favors may be used, as per consumer preference.

Ready to eat cold bean cake product 102 may further comprise at least one topping. Topping is selected from the group consisting of chocolate, caramel, butterscotch, apple sauce, fruit, nut, cereal, cheese, and cream. Other toppings may be used, as per consumer preference. Ready to eat cold bean cake product 102 may further comprise a salt source. Salt source is preferably selected from the group consisting of salt, pepper, garlic, ginger, onion, chili, curry, vinegar, lemon, lime, basil, thyme, rosemary, parsley, peppermint, rosemary, clove, cinnamon, coriander, cumin, shallot, soup stock (or broth) to make salty version of bean cakes 112. Vegetables, when used for salt source, are preferably selected from the group consisting of onion, garlic, spinach, mushroom, carrot, corn, beet, radish, turnip, pepper, tomato, asparagus, cucumber, zucchini, eggplant, squash, pea, avocado, shallot, and yam.

Ready to eat cold bean cake product 102 may further comprise a seafood. Seafood, when used, is selected from the group consisting of squid, cuttlefish, shrimp, crab, crayfish, clam, oyster, scallop, lobster, abalone, conch, octopus, jellyfish, prawn, krill, mussel, sea cucumber, sea urchin, eel, snail, shrimp roe, fish roe, and fish. Ready to eat cold bean cake product 102 may further comprise meat in alternate embodiments. Meat, when used, is selected from the group consisting of chicken, duck, pork, beef, lamb, bacon, and sausage. Other meats and/or seafoods may be used, as per consumer preference.

In alternate embodiments ready to eat cold bean cake product 102 may further comprise fruit; wherein fruit is preferably selected from the group consisting of apple juice, orange juice, lemon juice, lime juice, grapefruit juice, grape juice, pear juice, cranberry juice, blueberry juice, pineapple juice, pomegranate juice, and coconut juice, in order to make fruity bean cakes.

Ready to eat cold bean cake product 102 may further comprise cooking oils to make flavored bean cakes 112; cooking oils are preferably selected from the group consisting of corn oil, canola oil, peanut oil, olive oil, coconut oil, soybean oil, sesame oil, sunflower oil, flaxseed oil, grape seed oil, pumpkin seed oil, safflower oil, argan oil, rice bran oil, palm oil, and palm kernel oil. Additives 150 are selected from the group consisting of coffee, tea, chocolate, caramel, butterscotch, raisin, fruit, nut, cream, butter, peanut butter, cheese, and egg. As such many versions of the present invention may be available for consumption to match a user's taste and preference/dietary needs.

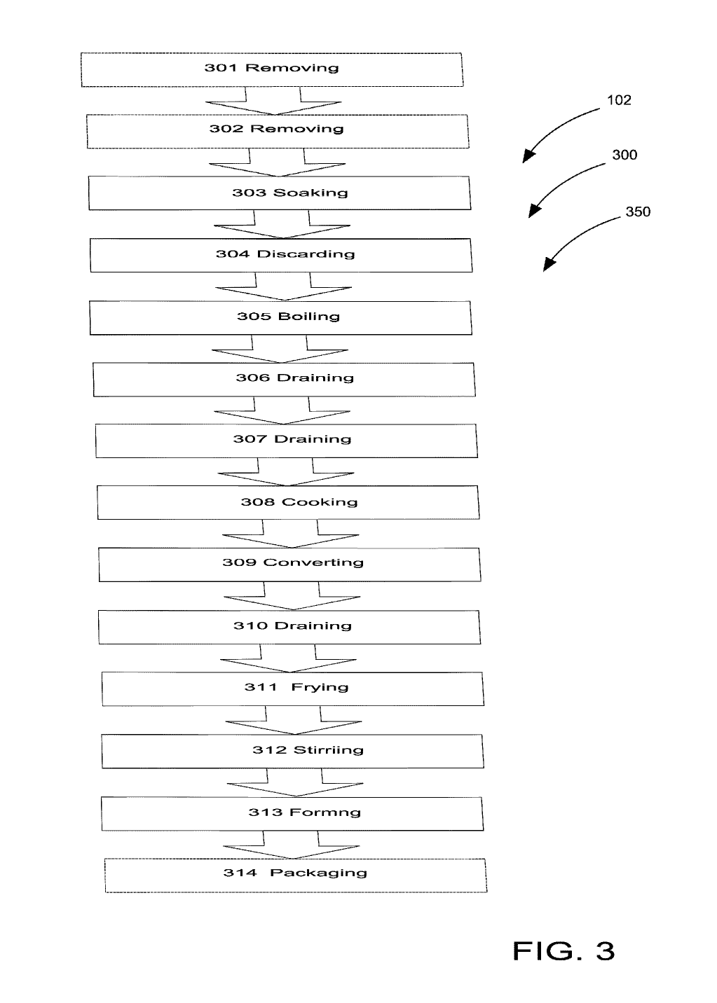

Referring now to FIG. 3, a flowchart 350 illustrating a method of preparing 300 ready to eat cold bean cakes 110 according to an embodiment of the present invention of FIGS. 1-2. Other methods are also disclosed (previously), but are not preferred.

A (preferred) method of preparing 300 ready to eat cold bean cakes 102 comprises the steps of: step one 301 removing beans 120 from plants; step two 302 removing the beans 120 from pods; step three 303 soaking beans 120 in soaking water at least one time; step four 304 discarding a plurality of batches of the soaking water to leach out hard to digest complex sugars that cause flatulence and bloating; step six 305 boiling beans 120 for 3 minutes in boiling water, then setting aside for 3 to 4 hours; step seven 306 draining and discarding the boiling water and proceeding with cooking; step seven 307 draining and discarding the boiling water and proceeding with cooking; step eight 308 cooking for 1 to 4 hours; step nine 309 draining the boiling water again; step ten 310 converting beans 120 into a paste with a masher to remove skins; step eleven 311 frying beans 120 with cooking oils; step twelve 312 stiffing and mixing with ingredients, seasonings and binding agent 140, and boiling until texture is soft and smooth; step thirteen 313 forming into bean cakes 112 and storing bean cakes 112 in a refrigerator to congeal and solidify; and step fourteen 314 packaging to preserve freshness once solidified.

Bean cakes 112 can be packaged into air tight containers to preserve freshness as ready to eat cold bean cake product 102. The containers can be made of paper, plastic, glass, metal. The serving size can be a single serving, or a six pack of servings. Each serving can be contained in a cubical shaped container, with each side of the container about 3 to 4 inches in length. Bean cakes 112 are stored in the refrigerator and ready to eat. Cold and ready to eat bean cakes 112 (ready to eat cold bean cakes 110) can be served as breakfast, lunch, dinner, desert, or as a snack food.

It should be noted that steps 301, 302, 314 are optional steps and may not be implemented in all cases. Optional steps of method 300 are illustrated using dotted lines in FIG. 3 so as to distinguish them from the other steps of method 300. Manual or automated means may be used.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A ready to eat cold bean cake product comprising ingredients combined in proportions substantially including:
beans;
milk;
a binding agent;
additives; and
flavorings;
wherein said beans are soaked, cooked, and processed;
wherein said milk, said binding agent, said additives and said flavorings are stirred, mixed as an admixture and formed into bean cakes as said ready to eat cold bean cake product;
wherein said binding agent causes said admixture to congeal after being cooked when said admixture is cooled using refrigeration;
wherein said flavorings cause said bean cakes to be flavored for consumption; and
wherein said bean cakes are high in nutrition and suitable for readily consuming.

2. The ready to eat cold bean cake product of claim 1 wherein said binding agent is an edible binder and comprises gelatin, egg white, beaten egg, which is high in protein.

3. The ready to eat cold bean cake product of claim 1 wherein said binding agent is an edible binder and comprises a starch component is selected from the group consisting of vegetable starch, corn starch, potato starch, sago, and tapioca.

4. The ready to eat cold bean cake product of claim 3 wherein said starch component, when used, allows said bean cakes to be reheated in a microwave oven and in a conventional oven.

5. The ready to eat cold bean cake product of claim 1 wherein said flavorings are selected from the group consisting of sugar, syrup, honey, and cinnamon to make sweet said bean cakes.

6. The ready to eat cold bean cake product of claim 1 further comprising a topping.

7. The ready to eat cold bean cake product of claim 6 wherein said topping is selected from the group consisting of chocolate, caramel, butterscotch, apple sauce, fruit, nut, cereal, cheese, and cream.

8. The ready to eat cold bean cake product of claim 1 further comprising a salt source.

9. The ready to eat cold bean cake product of claim 8 wherein said salt source is selected from the group consisting of salt, pepper, garlic, ginger, onion, chili, curry, vinegar, lemon, lime, basil, thyme, rosemary, parsley, peppermint, rosemary, clove, cinnamon, coriander, cumin, shallot, and soup stock to make salty said bean cakes.

10. The ready to eat cold bean cake product of claim 9 wherein said vegetables are selected from the group consisting of onion, garlic, spinach, mushroom, carrot, corn, beet, radish, turnip, pepper, tomato, asparagus, cucumber, zucchini, eggplant, squash, pea, avocado, shallot, and yam.

11. The ready to eat cold bean cake product of claim 1 further comprising a seafood.

12. The ready to eat cold bean cake product of claim 11 wherein said seafood is selected from the group consisting of squid, cuttlefish, shrimp, crab, crayfish, clam, oyster, scallop, lobster, abalone, conch, octopus, jellyfish, prawn, hill, mussel, sea cucumber, sea urchin, eel, snail, shrimp roe, fish roe, and fish.

13. The ready to eat cold bean cake product of claim 1 further comprising fruit, wherein said fruit is selected from the group consisting of apple juice, orange juice, lemon juice, lime juice, grapefruit juice, grape juice, pear juice, cranberry juice, blueberry juice, pineapple juice, pomegranate juice, and coconut juice, to make fruity said bean cakes.

14. The ready to eat cold bean cake product of claim 1 wherein said beans are selected from the group consisting of common beans, soy beans, green beans, kidney beans, red beans, pinto beans, white beans, yellow beans, black beans, lima beans, mung beans, broad beans, lentils, peas, and chickpeas.

15. The ready to eat cold bean cake product of claim 1 further comprising cooking oils to make flavored said bean cakes.

16. The ready to eat cold bean cake product of claim 15 wherein said cooking oils are selected from the group consisting of corn oil, canola oil, peanut oil, olive oil, coconut oil, soybean oil, sesame oil, sunflower oil, flaxseed oil, grape seed oil, pumpkin seed oil, safflower oil, argan oil, rice bran oil, palm oil, and palm kernel oil.

17. The ready to eat cold bean cake product of claim 1 wherein said additives are selected from the group consisting of coffee, tea, chocolate, caramel, butterscotch, raisin, fruit, nut, cereal, cream, butter, peanut butter, cheese, and egg.

18. The ready to eat cold bean cake product of claim 1 further comprising meat.

19. The ready to eat cold bean cake product of claim 18 wherein said meat is selected from the group consisting of chicken, duck, pork, beef, lamb, bacon, and sausage.

20. A method of preparing ready to eat cold bean cakes comprising the steps of:
removing beans from plants;
removing the beans from pods;
soaking the beans in soaking water at least one time;
discarding a plurality of batches of the soaking water to leach out hard to digest complex sugars that cause flatulence and bloating;
boiling the beans for 3 minutes in boiling water, then set aside for 3 to 4 hours;
draining and discarding the boiling water and proceeding with cooking;
cooking for 1 to 4 hours;
draining the boiling water again;
converting the beans into a paste with a masher to remove skins;
frying the beans with cooking oils;
stirring and mixing with ingredients, seasonings and binding agent, and boiling until texture is soft and smooth;
forming into bean cakes and storing the bean cakes in a refrigerator to congeal and solidify; and
packaging to preserve freshness once solidified.
